(19) United States
(12) Patent Application Publication
(10) Pub. No.: US 2018/0086055 A1
(43) Pub. Date: Mar. 29, 2018

(54) INKJET HEAD DRIVING DEVICE AND DRIVING METHOD

(71) Applicant: TOSHIBA TEC KABUSHIKI KAISHA, Tokyo (JP)

(72) Inventor: Jun TAKAMURA, Mishima Shizuoka (JP)

(21) Appl. No.: 15/694,932

(22) Filed: Sep. 4, 2017

(30) Foreign Application Priority Data
Sep. 23, 2016 (JP) 2016-186170

(51) Int. Cl. B41J 2/045

(52) U.S. Cl. CPC B41J 2/04541; B41J 2/04596; B41J 2/04586

(57) ABSTRACT

According to one embodiment, an inkjet head driving device includes an ejection pulse generation circuit configured to generate an ejection pulse to be applied to an actuator for ejecting ink from a pressure chamber connected to a nozzle, and an expansion pulse generation circuit configured to generate an expansion pulse to be applied to the actuator after at least one ejection pulse, the expansion pulse causing the actuator to expand a volume of the pressure chamber to prevent ink from being ejected from the nozzle.

### CROSS-REFERENCE TO RELATED APPLICATION

This application is based upon and claims the benefit of priority from Japanese Patent Application No. 2016-186170, filed Sep. 23, 2016, the entire contents of which are incorporated herein by reference.

### FIELD

Embodiments described herein relate generally to a driving device and a driving method for an inkjet head.

### BACKGROUND

In an inkjet head, an ink droplet ejected from a nozzle usually leaves a trailing portion of ink or a droplet tail. Upon exiting the nozzle, the trailing portion of ink, which may also be referred to as a liquid column, breaks up into small, spherical droplets (satellite droplets), following the main ink droplet. The satellite droplets are minute in size and thus generally lower in travelling velocity than that of the main ink droplet. These satellite droplets may cause unwanted splashes or variations in ink density on a printing medium, thus reducing printing quality. Moreover, some of the satellite droplets may scatter and form an ink mist inside the inkjet printer. The ink mist may adhere to, for example, an inkjet head or circuits in the inkjet head or therearound and cause a malfunction. Therefore, there is a demand for preventing the occurrence of satellite droplets and ink mists without impairing the ejection stability of a main ink droplet.

### BRIEF DESCRIPTION OF THE DRAWINGS

FIG. 1 is an exploded perspective view of an inkjet head.

FIG. 2 is a transverse cross-sectional view of an inkjet head.

FIG. 3 is a longitudinal cross-sectional view of an inkjet head.

FIGS. 4A, 4B, and 4C are schematic views illustrating aspects of an operating principle of an inkjet head.

FIG. 5 is a waveform chart of drive pulse signals S1 and S2 to be applied to an actuator for an inkjet head according an embodiment.

FIG. 6 is a block configuration diagram of an inkjet head driving device according to an embodiment.

FIG. 7 is a timing chart of drive pulse waveforms that are output when dot printing is performed in a multi-drop method according to an embodiment.

FIGS. 8A, 8B, 8C, 8D, 8E, and 8F are schematic views of a meniscus of ink in a nozzle when a waveform of the drive pulse signal S2 is applied to an actuator.

FIG. 9 is a timing chart of a pressure waveform of a pressure chamber and a flow velocity waveform of ink when drive pulse signal S1 is applied to an actuator.

FIG. 10 is a timing chart of a pressure waveform of a pressure chamber and a flow velocity waveform of ink when drive pulse signal S2 in which a satellite removal time is set to a quarter of AL time is applied to an actuator.

FIG. 11 is a timing chart of a pressure waveform of a pressure chamber and a flow velocity waveform of ink when drive pulse signal S2 in which a satellite removal time is set to twice of AL time is applied to an actuator.

### DETAILED DESCRIPTION

In general, according to one embodiment, An inkjet head driving device includes an ejection pulse generation circuit configured to generate an ejection pulse to be applied to an actuator for ejecting ink from a pressure chamber connected to a nozzle, and an expansion pulse generation circuit configured to generate an expansion pulse to be applied to the actuator after at least one ejection pulse, the expansion pulse causing the actuator to expand a volume of the pressure chamber to prevent ink from being ejected from the nozzle.

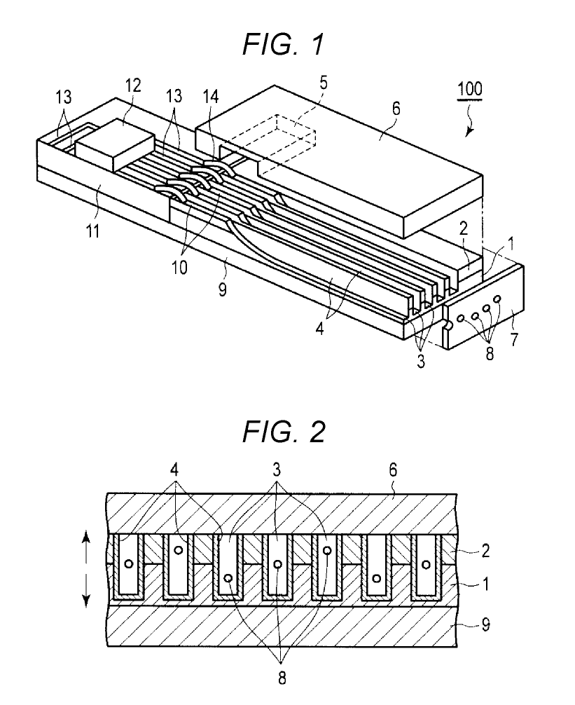

Hereinafter, an inkjet head driving device and an inkjet head driving method according to example embodiments will be described with reference to the drawings. The ink jet head driving device(s) in the example embodiments can prevent the occurrence of satellite droplets and ink mists without impairing the ejection stability of a main ink droplet. In the example embodiments, an inkjet head 100 is a shared wall type (see FIG. 1).

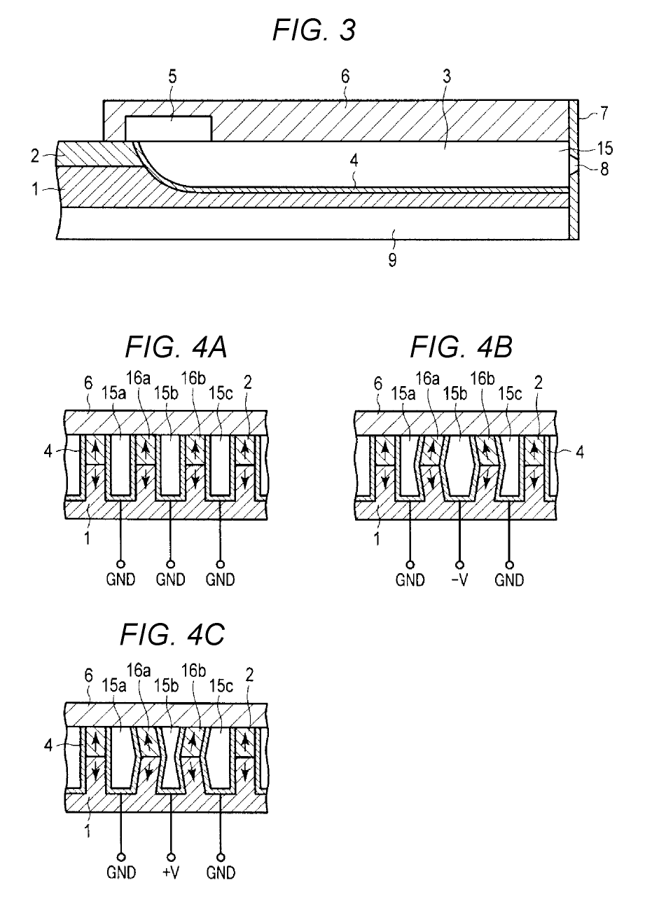

First, a configuration of the inkjet head 100 (hereinafter abbreviated as a “head 100”) is described with reference to FIG. 1 to FIG. 3. FIG. 1 is an exploded perspective view illustrating a part of the head 100. FIG. 2 is a transverse cross-sectional view of the head 100. FIG. 3 is a longitudinal cross-sectional view of the head 100. Furthermore, a direction parallel to a length of the head 100 is referred to as a “longitudinal direction”, and a direction perpendicular to the longitudinal direction is referred to as a “transverse direction”.

As illustrated in FIG. 1, the head 100 has a rectangular base substrate 9. In the head 100, a first piezoelectric plate 1 is attached to an upper surface of the base substrate 9, and a second piezoelectric plate 2 is attached to the first piezoelectric plate 1. The first piezoelectric plate 1 and the second piezoelectric plate 2, which are bonded to each other, have polarizations opposite directions along a direction parallel to thickness of the piezoelectric plates 1 and 2, as indicated by the arrows in FIG. 2.

The base substrate 9 is formed by a material having a small dielectric constant and a small difference of a thermal expansion coefficient from the piezoelectric plates 1 and 2. Examples of desirable materials used to form the base substrate 9 include alumina (Al₂O₃), silicon nitride (Si₃N₄), silicon carbide (SiC), aluminum nitride (AlN), and piezoelectric zirconate titanate (PZT). Examples of materials used to form the piezoelectric plates 1 and 2 include piezoelectric zirconate titanate (PZT), lithium niobate (LiNbO₃), and lithium tantalate (LiTaO₃).

The head 100 includes multiple elongate grooves 3 cut from an upper surface of the piezoelectric plate 1 piezoelectric plate 1 toward a bottom surface of the piezoelectric plate 2. The grooves 3 are equally spaced and are parallel with one another. Each groove 3 has an open upper end and closed bottom end. A cutting and processing machine can be used to form the grooves 3.

As illustrated in FIG. 2 and FIG. 3, the head 100 has an electrode 4 on inner walls of each groove 3. The electrode 4 has a two-layered structure configured with nickel (Ni) and gold (Au). The electrode 4 is uniformly formed as a film on the inside of each groove 3, for example, by a plating method. The method for forming the electrode 4 is not limited to the plating method. For example, a sputtering method or an evaporation method can be used.

As illustrated in FIG. 1, the head 100 includes an extraction electrode 10 at rear edge of each groove 3 toward a rear upper surface of the second piezoelectric plate 2. The extraction electrode 10 is connected to the electrode 4.

As illustrated in FIG. 1 and FIG. 3, the head 100 includes a top plate 6 and an orifice plate 7. The top plate 6 covers the upper ends of the grooves 3. The orifice plate 7 closes front edges of grooves 3. In the head 100, each of a plurality of pressure chambers 15 is formed in one groove 3 shielded by the top plate 6 and the orifice plate 7. The pressure chambers 15 each have, for example, a depth of 300 μm and a width of 80 μm, and are arranged in parallel with each other at a pitch of 169 μm. However, due to, for example, variations in manufacturing characteristics of a cutting and processing machine used in forming the plurality of pressure chambers 15, shapes of the pressure chambers 15 are not necessarily uniform. For example, the cutting and processing machine may form 16 pressure chambers 15 at once and this operation can be repeated 20 times to form 320 pressure chambers 15. However, if cutting blades used to form each of 16 pressure chambers 15 at once have individual differences, then resulting shapes of the pressure chambers 15 will have similar differences due to the differences in the machine blades resulting in a periodicity in the shapes of the pressure chambers 15 across the nozzle array. Additionally, the shapes of each pressure chamber 15 may also slightly change due to, for example, a change in a processing temperature during the repetitive processing operations (e.g., 20 passes of the cutting tool). A slight change in shapes of pressure chambers 15 may lead to an uneven ink density.

The top plate 6 includes a common ink chamber 5 at a rear bottom surface of the top plate 6. The orifice plate 7 includes nozzles 8 facing the grooves 3, respectively. Each nozzle 8 communicates with the facing groove 3, and also facing the ink chamber 15. The nozzle 8 is tapered from the pressure chamber 15 toward an ink ejection side, which is opposite of the pressure chamber 15. The nozzles 8 corresponding to three adjacent pressure chambers 15 are grouped, and within each group heights of the three nozzles are shifted at a constant interval in the height direction of the groove 3 (in the vertical direction as viewed in FIG. 2). In FIG. 2, the nozzle 8 is schematically illustrated so as to enable understanding the position of the nozzle 8. The nozzle 8 can be formed by, for example, a laser processing machine. There are two methods for determining positions of nozzles 8 to be formed by the laser processing machine. One method is optically setting a position of a laser beam. The other method is mechanically moving a workpiece (e.g., the orifice plate 7), while the laser stays stationary. For a large number of nozzles 8, both methods may be used in combination. However, if hole drilling is performed using both the optical positioning method and the mechanical positioning method in combination, then periodic errors may occur in shapes of the holes due to a minute change during each repeated positioning processing. The possible periodicity in the shapes or positioning of the hole produced by laser processing is also one of the causes for a minute periodic errors leading to an uneven density.

As illustrated in FIG. 1, in the head 100, a printed circuit board 11 having a conductive pattern 13 formed thereon is attached on a rear upper surface of the base substrate 9. In the head 100, a drive integrated circuit (IC) 12, installed thereon is mounted on the printed circuit board 11. In the drive IC 12, an ink jet head drive device 20, which will be described below, is embedded. The drive IC 12 is connected to the conductive pattern 13. The conductive pattern 13 is bound to the extraction electrodes 10 via conductive wires 14 by wire bonding. One drive IC 12 alone may drive the electrodes corresponding to all of the nozzles 8. However, when one drive IC drives a large number of electrodes, there are several disadvantages. For example, the chip size increases and thus a yield decreases, wiring of an output circuit is complicated, heat generation at the time of driving concentrates, and it is impossible to address an increase or decrease in the number of nozzles by increasing or decreasing the number of drive ICs. Therefore, for example, in a head with 320 nozzles 8, four drive ICs 12, each having 80 output circuits, can be used. However, in this case, an output waveform from the driver ICs 12 has a spatial periodicity in the direction of the array of the nozzles 8 due to, for example, differences in interconnection resistance in the drive IC 12. The intensity of the spatial periodicity of the output waveform varies depending on, for example, individual differences among the drive IC 12. The spatial periodicity of the output waveform may also lead to an uneven ink.

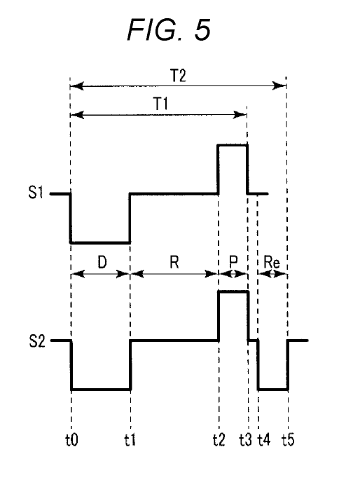

Next, an operating principle of the head 100 configured in the above-described way is described with reference to FIGS. 4A, 4B, 4C, 5.

In FIG. 4A, all of the electric potentials of the electrodes 4, on the inner walls of the pressure chambers 15a, 15b, and 15c are a ground potential GND. In this state, neither a partition wall 16a located between the pressure chamber 15a and the pressure chamber 15b nor a partition wall 16b located between the pressure chamber 15b and the pressure chamber 15c is subject to any distortion. The state illustrated in FIG. 4A is referred to as a “normal state”.

In FIG. 4B, a negative voltage −V is applied to the electrode 4 in the pressure chamber 15b and the potentials of the electrodes 4 in the pressure chambers 15a and 15c remain at the ground potential GND. In this state, an electric field due to the voltage −V acts on the partition walls 16a and 16b in a direction perpendicular to the polarization directions of the piezoelectric plates 1 and 2. This action causes the partition walls 16a and 16b to deform outward so as to expand a volume of the pressure chamber 15b. The state illustrated in FIG. 4B is referred to as an “expanded state”.

In FIG. 4C, a positive voltage +V is applied to the electrode 4 in the pressure chamber 15b and the potentials of the electrodes 4 of the pressure chambers 15a and 15c remain at the ground potential GND. In this state, an electric field due to the voltage +V acts on the partition walls 16a and 16b in a direction opposite to the direction of the deformation of the partition walls 16a and 17 in FIG. 4B. This action causes the partition walls 16a and 16b to deform inward so as to contract the volume of the pressure chamber 15b. The state illustrated in FIG. 4C is referred to as a “contracted state”.

Thus, when the nozzle 8 ejects an ink droplet while communicating with the pressure chamber 15b, at first, in the head 100, the pressure chamber 15b changes from the normal state to the expanded state, in a first step. When the pressure chamber 15b enters the expanded state, as illustrated in FIG. 4B, the partition walls 16a and 16b on both sides of the pressure chamber 15b deform outward so as to expand the volume of the pressure chamber 15b. This deformation decreases the pressure in the pressure chamber 15b, so that ink flows from the common ink chamber 5 into the pressure chamber 15b.

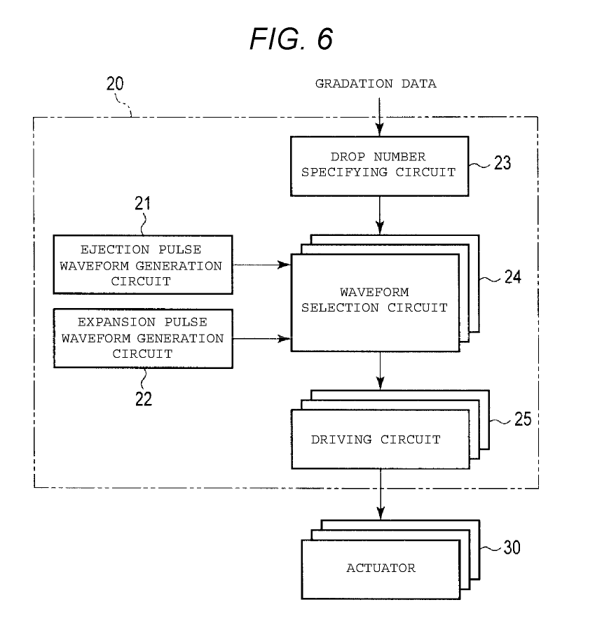

Next, in a second step, the pressure chamber 15b changes from the expanded state to the normal state. When the pressure chamber 15b returns to the normal state, as illustrated in FIG. 4A, the partition walls 16a and 16b on both sides of the pressure chamber 15b are restored to the normal state. This restoration increases the pressure in the pressure chamber 15b, so that an ink droplet is ejected from the nozzle 8 corresponding to the pressure chamber 15b. In this way, the partition wall 16a, which separates the pressure chambers 15a and 15b, and the partition wall 16b, which separates the pressure chambers 15b and 15c, serve as an actuator 30 (see FIG. 6), which generates a pressure vibration inside of the pressure chamber 15b, which has the partition walls 16a and 16b as wall surfaces thereof.

Next, in a third step the pressure chamber 15b changes from the normal state to the contracted state. When the pressure chamber 15b enters the contracted state, as illustrated in FIG. 4C, the partition walls 16a and 16b on both sides of the pressure chamber 15b deform inward so as to contract the volume of the pressure chamber 15b. This deformation further increases the pressure in the pressure chamber 15b. After an ink droplet is ejected, the pressure in the pressure chamber 15b decreases, so that pressure vibration remaining in the pressure chamber 15b is canceled.

In a fourth step, the pressure chamber 15b changes from the contracted state to the normal state. When the pressure chamber 15b returns to the normal state, as illustrated in FIG. 4A, the partition walls 16a and 16b on both sides of the pressure chamber 15b are restored to the normal state.

FIG. 5 is a waveform of drive pulse signals S1 and S2 which are applied to the actuator 30 for the pressure chamber 15b so as to achieve the above-described operations in the first to fourth steps. The drive pulse signal S1 is applied to the actuator 30 for the middle droplets in a series of ejected droplets when the head 100 is being driven in a multi-drop method in which one dot being formed from a plurality of ink droplets. The drive pulse signal S2 is applied to the actuator 30 for the last ink droplet in the series of ejected droplets in the multi-drop method in which one drop is being printed.

In FIG. 5, time durations T1 and T2 each are a length of time required to eject one ink droplet by the drive pulse S1 and the drive pulse S2, respectively. The time duration T1 for the drive pulse signal S1 includes an ink draw-in time D, an ink ejection time R, and a cancel time P. The time T2 for the drive pulse signal S2 includes a satellite removal time Re in addition to the ink draw-in time D, the ink ejection time R, and the cancel time P.

The ink draw-in time D is equal to one half of the natural vibration period of the pressure chamber 15 (hereinafter referred to as an “AL time”). The ink ejection time R can be an arbitrary value between the AL time and twice of the AL time. The cancel time P is an arbitrary value equal to or less than the AL time. The ink draw-in time D, the ink ejection time R, and the cancel time P are usually set to appropriate values based on conditions, such as a type of ink to be used and operating temperature, for each head 100.

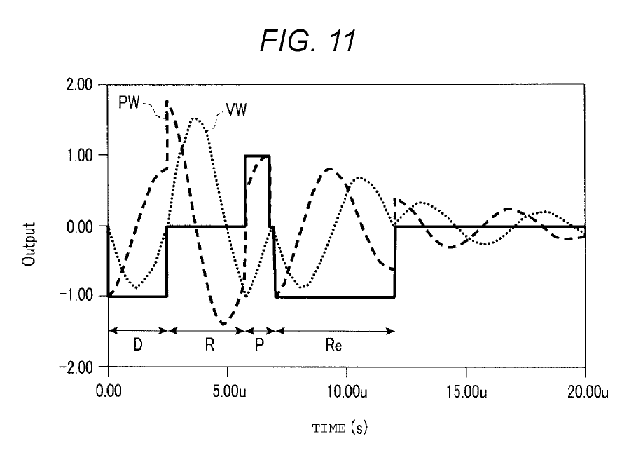

The satellite removal time Re can be equal to or less than a half of the AL time or twice of the AL time. For the satellite removal time Re being equal to or less than a half of the AL time, even when the partition walls 16a and 16b on both sides of the pressure chamber 15b are restored to the normal state after the satellite removal time Re elapses, no ink droplet is ejected from the nozzle 8 communicating with the pressure chamber 15b (see FIG. 10). For the satellite removal time Re being equal to twice of the AL time, no ink droplet is ejected from the nozzle 8 communicating with the pressure chamber 15b (see FIG. 11).

Such drive pulse signals S1 and S2 are generated by the inkjet head driving device 20 (also referred to for simplicity as a “driving device 20”), which is installed on the drive IC 12. The drive pulse signals S1 and S2 are applied to the actuator 30.

FIG. 6 is a block diagram of the driving device 20. The driving device 20 includes an ejection pulse waveform generation circuit 21, an expansion pulse waveform generation circuit 22, a drop number specifying circuit 23, waveform selection circuits 24, and driving circuits 25. The waveform selection circuits 24 and the driving circuits 25 are paired with every actuator 30. The ejection pulse waveform generation circuit 21, the expansion pulse waveform generation circuit 22, and the drop number specifying circuit 23 are provided in common for every actuator 30.

The ejection pulse waveform generation circuit 21 generates an ejection pulse waveform. The ejection pulse waveform includes a first pulse waveform for applying a voltage −V to the actuator 30 during the ink draw-in time D, a waveform for setting the electric potential of the actuator 30 to the ground potential GND during the ink ejection time R following the first pulse waveform, and a second pulse waveform for applying a voltage +V to the actuator 30 during the cancel time P after the ink ejection time R has elapsed.

The expansion pulse waveform generation circuit 22 generates an expansion pulse waveform for applying a voltage −V to the actuator 30 during an arbitrary time duration equal to or less than a half of the AL time or for twice of the AL time.

The drop number specifying circuit 23 specifies the number of ink droplets to be ejected from the nozzle 8 within one dot, referred to as a drop number, based on gradation data. The gradation data is given from, for example, a controller of the printer. In the present example, gradation printing by the multi-drop method for forming one dot from up to 7 drops is available.

The waveform selection circuit 24 selects an ejection pulse waveform and an expansion pulse waveform based on the drop number specified by the drop number specifying circuit 23. More specifically, the waveform selection circuit 24 adds a number of ejection pulse waveforms equivalent to the drop number and, then add one expansion pulse waveform in a waveform for outputting to the driving circuit 25.

The driving circuit 25 then outputs a drive pulse signal S1 or S2, based on the waveform generated by the waveform selection circuit 24, to the actuator 30, thereby driving the actuator 30.

Here, the ejection pulse waveform generation circuit 21, the waveform selection circuit 24, and the driving circuit 25 configure an ejection pulse application unit. The expansion pulse waveform generation circuit 22, the waveform selection circuit 24, and the driving circuit 25 configure an expansion pulse application unit.

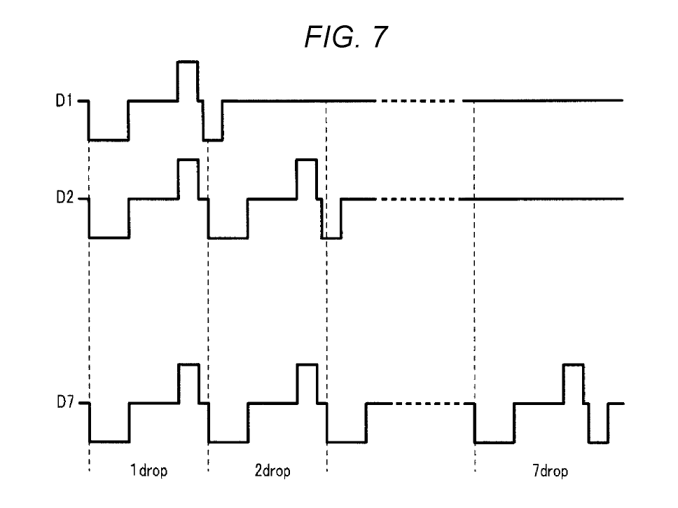

FIG. 7 is a timing chart illustrating a drive pulse waveform D1 generated when the drop number specified by the drop number specifying circuit 23 is “1”, a drive pulse waveform D2 generated when the drop number is “2”, and a drive pulse waveform D7 generated when the drop number is “7”.

When the drop number is “1”, the waveform selection circuit 24 includes just one ejection pulse and then includes one expansion pulse. Accordingly, as indicated by the waveform D1, the waveform of the drive pulse signal S2 is applied to the actuator 30 for this one droplet ejection.

When the drop number is “2”, the waveform selection circuit 24 includes two ejection pulses and then includes one expansion pulse. Accordingly, as indicated by the waveform D2, a waveform of one drive pulse signal S1 followed by a waveform of the drive pulse signal S2 is applied to the actuator 30.

When the drop number is “7”, the waveform selection circuit 24 includes seven ejection pulses and then includes one expansion pulse. Accordingly, as indicated by the waveform D7, a waveform including six drive pulse signals S1 in repetition and followed by a waveform of the drive pulse signal S2 is applied to the actuator 30.

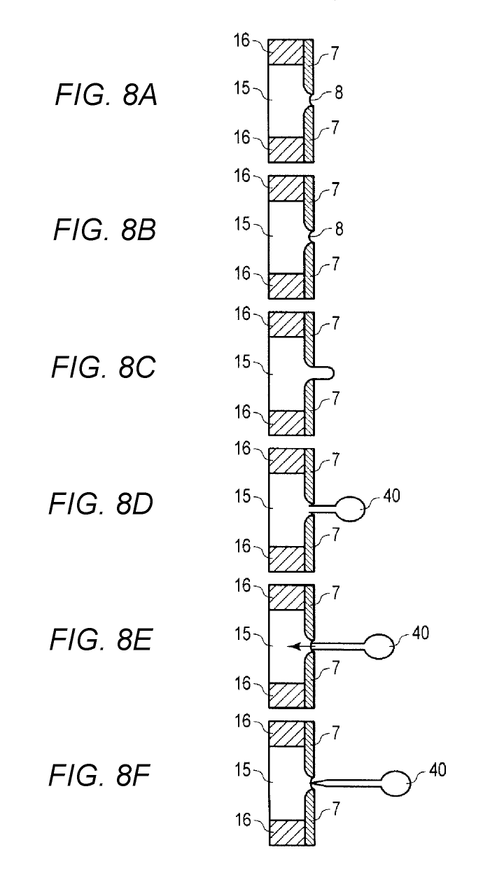

FIGS. 8A, 8B, 8C, 8D, 8E, and 8F are schematic views of the motion of a meniscus of ink in the nozzle 8 when the waveform of the drive pulse signal S2 as illustrated in FIG. 5 is applied to the actuator 30.

FIG. 8A illustrates the state of a meniscus before the drive pulse signal S2 is applied, at a time before t0. At time to, a voltage −V is applied to the actuator 30 based on an ejection pulse so that the pressure chamber 15 is expanded, and thus a pressure in the pressure chamber 15 drops. Then, the pressure chamber 15 remains expanded for the ink draw-in time D, being set to be equal to the AL time, while ink flows from the common ink chamber 5 into the pressure chamber 15. As illustrated in FIG. 8B, a meniscus located at an end of the nozzle 8 recedes toward the pressure chamber 15 as ink flows into the pressure chamber 15.

After the ink draw-in time D has elapsed, at time t1, the electric potential of the actuator 30 is set to the ground potential GND based on the ejection pulse so that the pressure chamber 15 is restored in the normal state, and thus a pressure in the pressure chamber 15 increases. Since a pressure wave generated by the positive pressure coincides in phase with a pressure wave generated by a voltage −V being applied to the actuator 30, the amplitude of the pressure wave increases drastically. According to such an increase in amplitude, as illustrated in FIG. 8C, the meniscus in the nozzle 8 starts moving outward of the pressure chamber 15.

The outward movement of the meniscus continues for the ink ejection time R, being set to be between the AL time and twice of the AL time. During the ink ejection time R, as illustrated in FIG. 8D, a main ink droplet 40 is ejected while leaving a trail or tail portion of ink, and this liquid column of ink is about to separate from the nozzle 8. At time t2 immediately before this separation of the tail portion from the nozzle 8, a voltage +V is applied to the actuator 30 so that the pressure chamber 15 contracts, and thus a positive pressure change occurs in the pressure chamber 15. This pressure increases causes to eject a main portion of the droplet of ink 40.

After the cancel time P has elapsed, at time t3, the electric potential applied to the actuator 30 is set to the ground potential GND so that the pressure chamber 15 is restored to the normal state, and thus a negative pressure change occurs in the pressure chamber 15. This pressure decrease restrains residual vibration in the pressure chamber 15.

At time t4, a voltage −V is applied to the actuator 30 so that the pressure chamber 15 expands, a negative pressure change occurs in the pressure chamber 15. According to this pressure decrease, a rear portion of the liquid column of ink is pulled in toward the nozzle 8 as illustrated in FIG. 8E. Subsequently, during the satellite removal time Re, the rear portion of the liquid column becomes tapered as illustrated in FIG. 8F. Accordingly, the liquid column is prevented from breaking into satellite droplets following the main ink droplet 40. The satellite droplets are also prevented from forming an ink mist inside the inkjet printer.

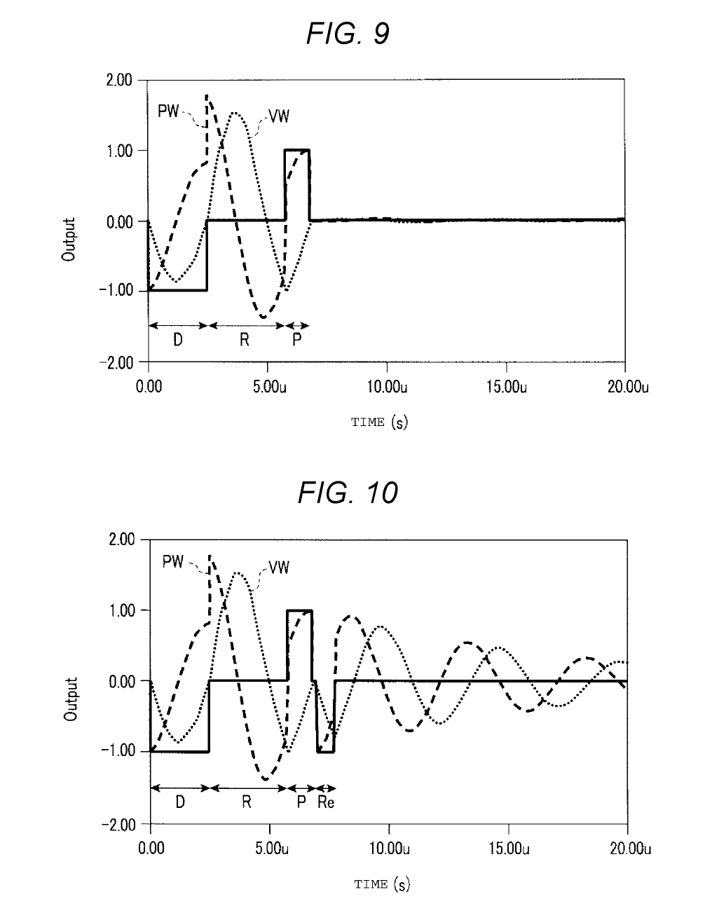

FIG. 9 is a timing chart illustrating a pressure waveform PW of the pressure chamber 15 and a flow velocity waveform VW of ink when the drive pulse signal S1 corresponding to the ejection pulse waveform is applied to the actuator 30. As illustrated in FIG. 9, when the ink draw-in time D elapses after the falling edge of the ejection pulse waveform, the ink ejection time R then elapses, and the cancel time P then elapses, the pressure in the pressure chamber 15 and the flow velocity of ink becomes zero. That is, residual vibration in the pressure chamber 15 is canceled. However, the occurrence of satellite droplets or an ink mist is not taken into consideration.

FIG. 10 is a timing chart illustrating the pressure waveform PW of the pressure chamber 15 and the flow velocity waveform VW of ink when the drive pulse signal S2, including an ejection pulse followed by an expansion pulse (having a satellite removal time Re set to a quarter of the AL time) is applied to the actuator 30. Similarly to FIG. 9, since each of the pressure in the pressure chamber 15 and the flow velocity of ink becomes zero according to the elapse of the cancel time P, residual vibration in the pressure chamber 15 is canceled. However, in the case of FIG. 10, after the end of the ejection pulse, an expansion pulse is applied. By this expansion pulse, a negative pressure change occurs in the pressure chamber 15 and the flow velocity of ink increases in a direction back toward the inside of the nozzle 8. Accordingly, since ink is pulled in toward the pressure chamber 15, the occurrence of satellite droplets and an ink mist can be prevented. After the satellite removal time Re, set to a quarter of the AL time, the electric potential of the actuator 30 returns to the ground potential based on the expansion pulse, and thus the pressure in the pressure chamber 15 continues to be lower and the flow velocity of ink is in the direction toward the pressure chamber 15, an ink droplet is prevented from being erroneously ejected.

FIG. 11 is a timing chart illustrating the pressure waveform PW of the pressure chamber 15 and the flow velocity waveform VW of ink when the drive pulse signal S2, including an ejection pulse and an expansion pulse having the satellite removal time Re set to twice of the AL time, is applied to the actuator 30. Similarly to FIGS. 9 10, the pressure in the pressure chamber 15 and the flow velocity of ink becomes zero at the end of the ejection pulse, due to the second pulse waveform for the cancel time P, and residual vibration in the pressure chamber 15 is canceled. Similarly to FIG. 10, after the end of the ejection pulse, an expansion pulse is applied. By this expansion pulse, a pressure in the pressure chamber 15 decreases and the flow velocity of ink increases in the direction toward the pressure chamber 15. Accordingly, since ink is pulled in toward the pressure chamber 15, the occurrence of satellite droplets and an ink mist can be prevented. In FIG. 11, when the satellite removal time Re elapses and the expansion pulse returns, the pressure in the pressure chamber 15 is negative and the flow velocity of ink is zero. Accordingly, an ink droplet is prevented from being erroneously ejected.

In this way, an ejection pulse is applied to the actuator 30 of a pressure chamber 15 to eject an ink droplet, and, after residual vibration in the pressure chamber 15 is attenuated, an expansion pulse is applied. By this expansion pulse, the pressure chamber 15 expands such that ink is not ejected. As a result, in the head 100, a negative pressure occurs in the pressure chamber 15 and the flow velocity of ink increases in the direction toward the pressure chamber 15, so that ink is pulled in toward the pressure chamber 15. Therefore, the occurrence of satellite droplets and an ink mist can be prevented. In this case, the waveform of the ejection pulse is not different from a usual one. Accordingly, the ejection stability of a main ink droplet is not impaired.

In the present embodiment, an energizing time for the expansion pulse can be set to be equal to or less than a quarter of the natural vibration period of the pressure chamber 15. Accordingly, since an energizing time for the expansion pulse used for preventing the occurrence of a satellite and an ink mist is short, there is no substantial obstacle to high-speed printing processes.

Furthermore, the energizing time for the expansion pulse can also be set to the natural vibration period of the pressure chamber 15. In this case, since the flow velocity of ink becomes zero at the end of the expansion pulse, erroneous ejection of ink can be reliably prevented.

Furthermore, satellite droplets and an ink mist have an influence on printing performed in the multi-drop method only for the last ink droplet ejected in a series droplet. Therefore, in the present embodiment, in the multi-drop method, an expansion pulse is added to an ejection pulse only for the last ink droplet being ejected. Accordingly, there is an advantage that the processing time required for printing of each dot can be reduced as compared with a case where the expansion pulse is added for every ink droplet being ejected.

The present disclosure is not limited to the above-described embodiment.

While the head 100 of the shared wall type is illustrated as an example, a head to which the driving device according to the present embodiment is applicable is not limited to a head 100 of a shared wall type. For example, to the head 100 may be a head in which nozzles are driven without being time-divisionally operated.

In addition, the configuration of the inkjet head driving device 20 is not limited to that illustrated in FIG. 6. The inkjet head driving device 20 may be any device that can apply an ejection pulse that causes pressure vibration in a pressure chamber 15 such that an ink droplet is ejected from the nozzle 8 and residual vibration in the pressure chamber 15 is attenuated after the ejection on the ink drop by an actuator 30, and subsequently being supplied with an expansion pulse, which causes the pressure chamber 15 to expand such that ink is not ejected from the nozzle 8.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet head driving device comprising:
an ejection pulse generation circuit configured to generate an ejection pulse to be applied to an actuator for ejecting ink from a pressure chamber connected to a nozzle; and
an expansion pulse generation circuit configured to generate an expansion pulse to be applied to the actuator after at least one ejection pulse, the expansion pulse causing the actuator to expand a volume of the pressure chamber to prevent ink from being ejected from the nozzle.

2. The inkjet head driving device according to claim 1, wherein the ejection pulse causes a pressure vibration in the pressure chamber to eject an ink droplet and then attenuates the pressure vibration in the pressure chamber.

3. The inkjet head driving device according to claim 2, wherein
the ejection pulse when applied to the actuator causes:
the pressure chamber to draw ink for an ink draw-in time equal to a half of a natural vibration period of the pressure chamber,
the ink droplet to be ejected from the nozzle for an ink ejection time equal to or less than a half of the natural vibration period of the pressure chamber, and
the pressure vibration in the pressure chamber to be attenuated for a cancel time equal to or less than the half of the natural vibration period of the pressure chamber.

4. The inkjet head driving device according to claim 1, wherein a pulse width of the expansion pulse is equal to or less than a half a natural vibration period of the pressure chamber.

5. The inkjet head driving device according to claim 1, wherein a pulse width of the expansion pulse is equal to a natural vibration period of the pressure chamber.

6. The inkjet head driving device according to claim 1, wherein an energizing time for the expansion pulse is equal to or less than a quarter of a natural vibration period of the pressure chamber.

7. The inkjet head driving device according to claim 1, wherein an energizing time for the expansion pulse is equal to a natural vibration period of the pressure chamber.

8. The inkjet head driving device to claim 1, further comprising:
a drop number specifying circuit configured to specify a number of drops to be ejected from the nozzle for one dot to be printed; and
a selection circuit configured to add the ejection pulse generated by the ejection pulse generation circuit to a output waveform for the number of drops specified by the drop number specifying circuit and then add the expansion pulse generated by the expansion pulse generation circuit; and
a driving circuit configured to apply the output waveform from the selection circuit to the actuator.

9. An inkjet head comprising:
a nozzle;
a pressure chamber connected to the nozzle;
an actuator configured to change a pressure of the pressure chamber;
an ejection pulse generation circuit configured to generate an ejection pulse to be applied to the actuator for ejecting ink from the pressure chamber; and
an expansion pulse generation circuit configured to generate an expansion pulse to be applied to the actuator after at least one ejection pulse, the expansion pulse causing the actuator to expand a volume of the pressure chamber to prevent ink from being ejected from the nozzle.

10. The inkjet head according to claim 9, further comprising:
a drop number specifying circuit configured to specify a number of drops to be ejected from the nozzle for one dot to be printed; and
a selection circuit configured to add the ejection pulse generated by the ejection pulse generation circuit to a output waveform for the number of drops specified by the drop number specifying circuit and then add the expansion pulse generated by the expansion pulse generation circuit; and
a driving circuit configured to apply the output waveform from the selection circuit to the actuator.

11. The inkjet head according to claim 10, wherein the ejection pulse causes a pressure vibration in the pressure chamber to eject an ink droplet and then attenuates the pressure vibration in the pressure chamber.

12. The inkjet head according to claim 11, wherein
the ejection pulse when applied to the actuator causes:
the pressure chamber to draw ink for an ink draw-in time equal to a half of a natural vibration period of the pressure chamber,
the ink droplet to be ejected from the nozzle for an ink ejection time equal to or less than a half of the natural vibration period of the pressure chamber, and
the pressure vibration in the pressure chamber to be attenuated for a cancel time equal to or less than the half of the natural vibration period of the pressure chamber.

13. The inkjet head according to claim 9, wherein a pulse width of the expansion pulse is equal to or less than a half a natural vibration period of the pressure chamber.

14. The inkjet head according to claim 9, wherein a pulse width of the expansion pulse is equal to a natural vibration period of the pressure chamber.

15. The inkjet head according to claim 9, wherein an energizing time for the expansion pulse is equal to or less than a quarter of a natural vibration period of the pressure chamber.

16. The inkjet head according to claim 9, wherein an energizing time for the expansion pulse is equal to a natural vibration period of the pressure chamber.

17. The ink jet head drive device according to claim 9, wherein the ink jet head is a shared-wall type ink jet head.

18. An inkjet head driving method, comprising:
applying an ejection pulse to an actuator for ejecting ink from a pressure chamber connected to a nozzle; and
applying an expansion pulse to the actuator after at least one ejection pulse, the expansion pulse causing the actuator to expand a volume of the pressure chamber to prevent ink from being ejected from the nozzle.

19. The method according to claim 18, wherein the ejection pulse causes a pressure vibration in the pressure chamber to eject an ink droplet and then attenuates the pressure vibration in the pressure chamber

20. The method according to claim 18, wherein
the ejection pulse when applied to the actuator causes:
the pressure chamber to draw ink for an ink draw-in time equal to a half of a natural vibration period of the pressure chamber,
the ink droplet to be ejected from the nozzle for an ink ejection time equal to or less than a half of the natural vibration period of the pressure chamber, and
the pressure vibration in the pressure chamber to be attenuated for a cancel time equal to or less than the half of the natural vibration period of the pressure chamber.
